(19) United States
(12) Patent Application Publication
(10) Pub. No.: US 2011/0304146 A1
(43) Pub. Date: Dec. 15, 2011

(54) CONDUCTOR APPARATUS HAVING OPTIMIZED MAGNETIC RESISTANCE WITH RESPECT TO AT LEAST ONE MAGNETIC ELEMENT MOVING IN PROXIMITY THERETO

(75) Inventor: Eduard Surodin, Brooklyn, NY (US)

(73) Assignee: SURVAL, CORP., New York, NY (US)

(21) Appl. No.: 12/813,388

(22) Filed: Jun. 10, 2010

(51) Int. Cl. F03B 13/00; H02K 3/00

(52) U.S. Cl. 290/54; 310/180

(57) ABSTRACT

The conductor apparatus of the present invention remedies the drawbacks of all previously known conductor components (field coils, etc.) in electrical power generation systems, and in electromechanical systems (coil windings/stators in electrical motors, solenoids, etc.) by providing the same or greater level of Faraday induction efficiency, while optimizing (e.g., lowering) the level of magnetic resistance/reluctance with respect to relative motion between the conductor, and at least one magnetic element positioned in proximity thereto. The optimized magnetic resistance feature of the inventive conductor results from its unique geometric configuration and orientation of elements thereof, such that the novel conductor is only partially disposed proximal to one or more magnetic elements in a desirable pattern. The optimized magnetic resistance feature of the inventive conductor is extremely advantageous in that its utilization in electromechanical systems vastly increases their efficiency, reliability, and sustainability of operation, as well as lowers their cost of fabrication. In at least one inventive embodiment thereof, the inventive conductor is further improved by suspension thereof in a very cold environment during operation (such as being surrounded by a cryogenic material—liquid nitrogen, etc.)

### FIELD OF THE INVENTION

The present invention relates generally to components for electromagnetic systems for generating and/or for utilizing electrical power, and more particularly to conductor components operable for utilization, in conjunction with one or more mobile proximal magnetic elements, for electrical power generation, or for utilization of electrical power in electromechanical systems (motors, solenoids, etc.).

### BACKGROUND OF THE INVENTION

The multitude of electrical and electronic devices in common use today, from consumer appliances and computers to lighting systems and industrial machinery, all depend on a steady supply of electrical energy that is either delivered thereto through electrical transmission lines, that is stored in one or more electrical energy storage receptacles (such as batteries, power cells, etc.), and/or, less commonly, that may be at least in part generated on a periodic basis (such as through solar panels, or obtained by conversion from natural forces—e.g., geothermal energy, tides, ocean wave-motion, wind), by utilization of appropriate mechanical energy conversion/generation systems.

Naturally, as a result of the continued, and ever-increasing, proliferation of electrical and electronic devices and systems worldwide, as well as an increasing reliance on technological solutions, the demand for electrical energy has grown exponentially, and is expected to increase at an ever greater rate. Moreover, aggressive regulatory initiatives by many nations across the world to address public concerns about harm caused by carbon emissions from utilization of fossil fuels in vehicles, heating, and other industrial applications, involve mandating utilization of electrically powered vehicles and systems in order to meet stringent emission reduction targets. As electrically powered vehicles grow in popularity and drop in price, it is widely expected that public demand for electrical energy will skyrocket to unprecedented levels.

Unfortunately, the quest to reduce, and to eventually eradicate, the use of fossil fuels leads to a problematic “Catch-22” situation: while lower reliance on fossil fuels leads to increased demand for electrical energy, in many parts of the world, fossil fuels (and especially coal) are utilized in the process of large-scale electrical power generation (for public utilities, industrial use, etc.).

The most efficient alternative electrical power generation solutions that do not involve the use of fossil fuel, are (1) dam-and-turbine power generation plants (which can only be built in an extremely small number of geographic locations, as they must typically be positioned at a water reservoir (or equivalent), in generally remote areas), and (2) nuclear electrical power generation plants, which, while acknowledged as being very efficient and cost effective, are in very limited use due to deep public distrust of nuclear-based technologies and fears of the potential for devastation in case of a nuclear plant accident or meltdown.

Not surprisingly, in the quest for cheap, safe, and efficient generation of electrical energy without causing undesirable emissions or byproducts, the “holy grail” of modern society has long been the discovery of a “sustainable” electrical power generation solution that would be capable of utilizing natural phenomena (such as sunlight, wind, geothermal energy, etc) to cheaply generate electrical energy without any waste products.

Over many years, a great number of proposed solutions have been developed and introduced in an attempt to achieve the above goals, but with only a small measure of limited success. Previously known “sustainable” electrical power generation solutions can be split into two general categories: electrochemical power generation (hereinafter “ECPG”) systems and electromechanical power generation (hereinafter “EMPG”) systems.

ECPG systems rely on certain chemical reactions that, when triggered by a catalyst (or exposure thereto) result in generation of electricity. The most common type of ECPG systems are solar cells/panels where the exposure of the panels to sunlight serves as the necessary catalyst. While solar ECPG systems have gained some limited level of commercial success, these solutions are very unlikely to reach any widespread acceptance due to several critical flaws:
first, solar panels require exposure to sunlight, and are of no use in the absence thereof (such as before sunrise/after sunset, on a cloudy or overcast days, etc.), making them extremely unreliable,
second, solar panels are extremely inefficient, and their already very low efficiency drops even further as incident angles of sunlight radiation change outside a predetermined range, based on the panel's spatial orientation toward the sky,
third, both of the above factors dictate a fairly large minimum panel size for even residential application as well as require positioning on elevated areas with minimized obstruction thereof,
fourth, while certain solar panel systems are provided with automated orientation mechanisms that automatically move the panels in a manner that maximizes their exposure to the sun, such systems are particularly vulnerable to severe weather conditions (especially winds), and pose significant risks to surrounding areas; and
finally, as a result of the above-described drawbacks, and by the nature of their required composition and construction, previously known ECPG systems are also fragile, relatively expensive to fabricate, and costly and difficult to install and properly configure.

EMPG systems essentially convert mechanical motion to electrical energy by taking advantage of electromagnetic induction (i.e., a natural phenomena postulated under Faraday's Law, under Lenz's Law, and under related principles). Mechanical motion for such systems is typically obtained relatively directly (for example from wind turbines rotated by a wind of a certain minimum force blowing in a particular range of directions, or from reciprocal motion from movement in a body of water), or indirectly by first using a separate system to generate mechanical motion (typically from thermal energy), such as by using geothermal heat in conjunction with steam turbines. While conceptually EMPG-based solutions have a number of advantages, and address several key flaws of ECPG systems, nevertheless, in practical use, both types of above-described previously known EMPG solutions suffer from a number of serious drawbacks:

Direct Mechanical EMPG Solutions:
Direct mechanical EMPG solutions typically rely on capricious natural phenomena (such as wind or water movement), to serve as the source of the necessary mechanical motion, and accordingly are essentially useless in the absence thereof. As a result, such previously known EMPG solutions are extremely unreliable, are unable to operate in a sustained manner, and thus are almost never utilized as primary EMPG sources, rather typically serving in a supporting role (such as to supplement power grids, etc.).
Moreover, direct mechanical EMPG solutions, by their very nature, have limited scalability for non-novelty practical commercial applications (i.e., even the smallest size practical direct mechanical EMPG systems are fairly large).
Furthermore, direct mechanical EMPG solutions have always been designed and constructed to work with a specific type of motion source configured to derive motion from specific natural forces (e.g., a bladed wind turbine only derives motion from wind, while a water waves-based or tidal system only derives motion from movement of water through currents, weather, or tidal effects). As a result, they have virtually no flexibility, and have significant limitations in their geographic locations and in their topographic positioning and orientation. For example a water motion-based EMPG system is of little use on a still pond, while a wind-turbine-based EMPG system will not work in a forest clearing, unless the turbine is mounted on a sufficiently high elevated pole. This, and other above-noted factors also greatly limit the portability of practical EMPG systems.

Indirect Mechanical EMPG Solutions:
While indirect mechanical EMPG solutions are more reliable that natural phenomenon-based direct mechanical EMPG systems, they have enormous limitations in terms of their minimum size for practical applications (typically their minimum practical size is a small building structure or a portion thereof).
Indirect mechanical EMPG solutions are extremely limited in the geographic locations where they may be used and also very limited in their topographic positioning and orientation-fore example, a water motion-based system must be located at a body of water, while a geothermal-based system must be located at a source of geothermal energy.
Finally, by their very nature, indirect mechanical EMPG solutions have no portability whatsoever.

Thus, as discussed above, despite decades of development and many attempts, there is no previously known practical solution for generating electrical energy in a reliable and sustained manner, but utilizing natural phenomena as a catalyst (for ECPG systems), or as a direct or indirect source of mechanical energy (for EMPG systems).

One of the key causes for the inability of previously known and currently available EMPG systems to provide much needed solutions for highly efficient, reliable, and sustainable generation of electrical power, whether from direct or indirect sources of mechanical energy, is a phenomenon known as “electromagnetic resistance” (occasionally also referred to as “electromagnetic reluctance”). To understand the importance of this phenomenon and prior to discussing its very significant role as a limiting factor for previously known and currently available EMPG systems, it would be useful to first provide a brief overview of basic principles of electromagnetic induction and inductance-based electromechanical systems.

Electromagnetic induction is a natural phenomena postulated under Faraday's Law, under Lenz's Law, and under related principles. Faraday's law of induction describes a basic law of electromagnetism, which is involved in the working of a wide variety of most common electromechanical systems. The law states that: The induced electromotive force (hereinafter “EMF”) in any closed circuit is equal to the time rate of change of the magnetic flux through the circuit.

As was discussed above, the most common inductance-based electromechanical systems are EMPG systems that essentially convert mechanical motion to electrical energy by taking advantage of electromagnetic induction, and electromechanical (EM) motors, that utilize induction to produce mechanical motion from electrical energy delivered thereto (essentially acting as EMPG systems in reverse).

As is also noted above, the EMF generated by Faraday's law of induction due to relative movement of a circuit and a magnetic field is the phenomenon underlying most electrical generators and motors. When a permanent magnet (or other form of magnet) is moved relative to a conductor (most typically implemented as conductive wire wound in a coil configuration around a metal core—hereinafter collectively referred to as “wire coil”), or vice versa, an electromotive force is created.

If the wire coil is connected through an electrical load, electric current will flow through the wire coil as a result of the relative motion of the proximal magnet, and thus electrical energy is generated, converting the mechanical energy of relative motion between the wire coil and the magnet into electrical energy. Most electrical motors work under similar principles, but in reverse: when electrical power is delivered to the wire coil, the EMF causes the proximal magnet to move in a manner dictated by the configuration of the motor, thereby converting electrical energy supplied to the motor into mechanical force (typically rotary force).

Electrical generators, and other electromechanical systems utilizing EMF principles, have been known for over a century, and are in widespread use today. And while many improvements and enhancements to their operations have been made over the years, previously known EMF-based systems suffer from one drawback that has remained unsolved since these systems were first conceived: the need for all EMF-based systems to overcome electromagnetic reluctance/resistance (hereinafter referred to as “EMR”).

The principles behind EMR are well documented and are well known to anyone skilled in the art—therefore a detailed discussion of the EMR principles herein is not necessary. The key EMR principle to remember is that in EMPG systems, for start-up and operation thereof, the force of initial and continuous relative motion between the wire coils and corresponding magnets must be sufficient to overcome the EMR that is generated in the system as a result of the wire coil being wound around the metal core being placed in proximity with one or more magnets (the key factor in the strength of EMR in a particular EMF-based system is the distance between the wire coil and the corresponding magnet(s) (i.e., the closer the coil to the magnet(s), the greater the EMR effect)).

Accordingly, the crucial need to overcome EMR in all EMF-based systems may be summarized as being two-fold in scope:
(a) Start-up EMR threshold: the need to overcome the system's EMR in order to start the operation of the system:
   i. In EMPG systems, this threshold is the minimum motive force that must be delivered to the system in order to produce sufficient relative motion between the EM conductor and corresponding magnet(s) in order to initiate electrical power generation, and
   ii. In EM motors, this threshold is the minimum amount of electrical power that must be delivered to the motor in order to induce sufficient current in the EM conductor to initiate the desired relative motion in the corresponding rotor in order to initiate rotation thereof, and
(b) Sustained operation EMR threshold: the need to continue to overcome the system's EMR in order to maintain the operation of the system (applicable in both EMPG systems and EM motors.

The issue of EMR thresholds is of particular importance in the fields of sustained EMPG systems, such as wind turbine generators, wave-based generators, etc., where the need to overcome both start-up and sustained operation EMR thresholds is crucial, and flywheel (disc) based generators/uninterruptible power supply (UPS) systems, where the ability of the flywheel to continue to overcome the system's sustained operation EMR threshold is critical.

However, the challenge of addressing EMR is made much more complex by the fact that in conventional EMF-based systems, the strength of EMR in a system is proportional to the EMF-based system performance. Therefore, a reduction of the EMR effect in a conventional EMF-based system directly leads to the reduction of that system's performance. Accordingly, any design of a conventional EMF-based systems must make difficult decision in balancing the desired system performance with the need to overcome the corresponding EMR thresholds. It is thus not surprising that the need to overcome both of the aforementioned EMR thresholds, has been, and continues to be, a constant challenge in all previously known EMF-based systems, regardless of various improvements and developments applied thereto over the years.

Therefore, it is quite clear, that one of the ultimate, and heretofore unachieved, goals in EMF-based system design is solving the problem of reduction of the EMR effect, without negative impact on the EMF-based system's performance.

It would thus be desirable to provide an electromagnetic (EM) conductor component for use in electromechanical systems, that is operable to optimize the system's handling of the effects of EMR during operation thereof. It would also be desirable to provide an EM conductor component for use in electromechanical power generation and motor-type systems, that is operable to improve the efficiency, reliability, and sustainability thereof. It would further be desirable to provide an EM conductor component that can be produced in a wide variety of different geometric and mounting configurations for utilization in any type of electromechanical system, including, but not limited to, electromechanical systems based on rotating, oscillating, and/or reciprocating motion.

### BRIEF DESCRIPTION OF THE DRAWINGS

In the drawings, wherein like reference characters denote corresponding or similar elements throughout the various figures:

FIG. 1A shows a top plan view diagram, and a partial cross-section view diagram of a first exemplary embodiment of the electromagnetic conductor apparatus of the present invention, configured for advantageous utilization in various rotary-motion based electromechanical systems, in conjunction with at least one correspondingly configured magnet (shown as being implemented in a electromechanical power generation system by way of example);

FIG. 1B shows a partial cross-section view diagram of a second exemplary embodiment of the electromagnetic conductor apparatus of the present invention, configured for advantageous utilization in various rotary/reciprocating motion based in various electromechanical systems, in conjunction with at least one correspondingly configured magnet (shown as being implemented in a electromechanical power generation system by way of example);

FIG. 1C shows a partial cross-section view diagram of a third exemplary embodiment of the electromagnetic conductor apparatus of the present invention, configured for advantageous utilization in various rotary/reciprocating motion based in various electromechanical systems, in conjunction with at least one correspondingly configured magnet (shown as being implemented in a electromechanical power generation system by way of example);

FIG. 2 shows a partial cross-section view diagram of a first alternate exemplary embodiment of the electromagnetic conductor apparatus of the present invention, configured for advantageous utilization in various wave-motion electromechanical systems, in conjunction with at least one correspondingly configured magnet (shown as being implemented in a electromechanical power generation system by way of example);

FIG. 3A shows a partial cross-section view diagram of a second alternate exemplary embodiment of the electromagnetic conductor apparatus of the present invention, configured for advantageous utilization in various reciprocating motion electromechanical systems, in conjunction with at least one correspondingly configured magnet (shown as being implemented in a electromechanical power generation system by way of example);

FIG. 3B shows a partial cross-section view diagram of a third alternate exemplary embodiment of the electromagnetic conductor apparatus of the present invention, configured for advantageous utilization in various reciprocating motion electromechanical systems, in conjunction with at least one. correspondingly configured magnet (shown as being implemented in a electromechanical power generation system by way of example);

FIG. 4 shows a diagram in various views of an alternate exemplary embodiment of the inventive electromagnetic conductor apparatus, configured as a partial coil, for advantageous utilization in various rotary/reciprocating motion electromechanical systems, in conjunction with at least one correspondingly configured magnet;

FIG. 5 is an block diagram with a simplified cross-sectional view of an exemplary implementation of various embodiments of inventive electromagnetic conductor apparatus of FIGS. 1A-1C, and FIG. 4, shown, by way of example, as a component in an electromechanical electrical power generation system; and

FIG. 6 shows a top plan view diagram, and a partial cross-section view diagram of an exemplary embodiment of the electromagnetic conductor apparatus of the present invention, configured for advantageous utilization in various rotary-motion based electromechanical systems, in conjunction with at least one correspondingly configured magnet (shown as being implemented in a electrical motor system by way of example).

### SUMMARY OF THE INVENTION

The various embodiments of the conductor apparatus of the present invention, advantageously remedy and resolve the disadvantages and drawbacks of all previously known conductor components (field coils, etc.) in use in various electrical power generation systems, and in various electromechanical systems (coil windings/stators in electrical motors, solenoids, etc.). Specifically, the inventive conductor apparatus provides the same, or greater level of Faraday induction efficiency to the electromechanical system in which it is installed, while optimizing (e.g., lowering) the system's level of magnetic resistance/reluctance (“EMR”), with respect to relative motion between the conductor, and at least one magnetic element positioned in proximity thereto.

The optimized magnetic resistance feature of the inventive conductor apparatus results from its unique geometric configuration and from orientation of elements thereof, such that the novel conductor apparatus is only partially disposed proximal to one or more magnetic elements in one or more desirable predetermined patterns.

The optimized magnetic resistance feature of the inventive conductor is extremely beneficial in that its utilization in electromechanical systems vastly increases their efficiency, reliability, and sustainability of operation, as well as lowers their cost of fabrication. In at least one inventive embodiment thereof, the inventive conductor apparatus is further improved by suspension thereof in a very cold environment during operation (such as being immersed in a cryogenic material—e.g., liquid nitrogen, etc.).

In summary, revolutionary modifications in the shape and spatial configuration of the inventive conductor apparatus (hereinafter referred to as the “EM conductor”), with matching modifications in the shape and spatial configurations of the corresponding magnet(s)) that have been discovered by the inventor hereof, through a rigorous process of research, development, and experimentation, have resulted in creation of various alternate and exemplary embodiments thereof, shown and described herein, that maximize the positive effects of EMR in any EMF-based system, but without causing the system to suffer the negative effects of EMR (i.e., without generating (and thus without having to overcome) substantial corresponding EMF thresholds.

Thus, by way of example, an EMF-based system utilizing an inventive EM conductor and correspondingly configured magnet(s), can greatly boost system performance by positioning the novel EM conductor very close to the corresponding magnet(s) (e.g., as close as 0.001 mm, or closer), but without generating the corresponding high EMR thresholds, thus advantageously enabling the high performance EMF-based system to freely operate (when, for example, a conventionally designed EMF-based system of a similar scope, in which a wire coil was placed within 0.001 mm of the magnet(s), would be unable to even overcome the start-up EMR threshold and thus would not function at all).

Essentially, the key reason for the advantageous properties of the novel EM conductor, in addition to the shape and spatial configuration thereof, is the substantial absence of magnetic properties in the novel EM conductor (because the novel EM conductor does not utilize a magnetic core (for example, a core composed of a ferromagnetic material, such as iron), as do conventional wire coils used in previously known electromechanical systems, which are typically wound around a corresponding core). Accordingly, while the inventive EM conductor preferably has a high degree of electrical conductivity, its substantial lack of a magnetic field serves to prevent the formation of any significant EMR threshold in an EMF-based system equipped therewith.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF PREFERRED EMBODIMENTS

The conductor apparatus of the present invention remedies the drawbacks of all previously known electromagnetic (EM) conductor components (field coils, etc.) in electrical power generation systems, and in other electromechanical systems (coil windings/stators in electrical motors, solenoids, etc.) by providing the same or greater level of Faraday induction efficiency, while optimizing (e.g., lowering) the level of magnetic resistance/reluctance (“EMR”) with respect to relative motion between the novel EM conductor, and at least one magnetic element positioned in proximity thereto.

The optimized magnetic resistance feature of the inventive EM conductor results from its unique geometric configuration and orientation of elements thereof, such that the novel EM conductor is only partially disposed proximal to one or more magnetic elements in a desirable pattern. The optimized magnetic resistance feature of the inventive EM conductor is extremely advantageous in that its utilization in electromechanical systems vastly increases their efficiency, reliability, and sustainability of operation, as well as lowers their cost of fabrication. In at least one inventive embodiment thereof, the inventive EM conductor is further improved by suspension thereof in a very cold environment during operation (such as being surrounded by a cryogenic material—liquid nitrogen, etc.)

Advantageously, the EM conductor of the present invention may be readily utilized as a component in various embodiments of the novel scalable high efficiency adaptive electrical power generator, disclosed in described in the co-pending commonly assigned U.S. patent application, filed Jun. 10, 2010, entitled “SYSTEM AND METHOD FOR HIGH EFFICIENCY ADAPTIVE SUSTAINED GENERATION OF ELECTRICAL ENERGY” (hereinafter referred to as “HEAS Generator”, and “HEAS Generator Patent Application”), which is hereby incorporated by reference herein in its entirety.

Furthermore, the various embodiments of the inventive EM conductor shown and described below may be readily and advantageously implemented as a subcomponent in both existing and future electromechanical systems, during fabrication thereof, and/or as a retrofit subcomponent in currently installed systems, to vastly increases the electromechanical systems' efficiency, reliability, and sustainability of operation, as well as to lower their cost of operation and fabrication—all by optimizing how an electromechanical system utilizing at least one inventive EM conductor handles EMR.

The various embodiments of the novel EM conductor, shown and described herein, finally provide a working solution to the key goal of solving the problem of reduction of the EMR effect in EMF-based electromechanical systems, without negative impact on the EMF-based system's performance—advantageously, implementation of the novel EM conductor, along with herein-described modifications of corresponding magnet(s), enables anyone skilled in the art to produce an optimized EMF-based system that takes full advantage of increasing the positive effects of a high EMR in a system (i.e., increasing the system performance proportionally to the strength of the EMR), while substantially reducing or eliminating the negative effects of EMR on the system (i.e., greatly lowering, or eliminating, the aforementioned two EMR thresholds).

While the key factor in the strength of EMR in a particular EMF-based system is the distance between the wire coil and the corresponding magnet(s) (i.e., the closer the coil to the magnet(s), the greater the EMR effect), the full parameters of the EMR effect in a specific system are based on the following factors:
(1) the shape/size of the EM conductor (i.e., the wire coil in previously known EMF-based systems);
(2) the shape/size of the magnet(s) used in the EMF-based system;
(3) the material of the EM conductor;
(4) the material/type of corresponding magnet; and
(5) other, less important, miscellaneous factors (e.g., environmental factors, etc.)

In summary, revolutionary modifications in the shape and spatial configuration of the EM conductor (with matching modifications in the shape and spatial configurations of the corresponding magnet(s)) that have been discovered by the inventor hereof, through a rigorous process of research, development, and experimentation, have resulted in creation of various embodiments of the novel EM conductor, shown and described herein, that maximize the positive effects of EMR in any EMF-based system, but without suffering the negative effects of EM (i.e., without generating (and thus without having to overcome) substantial corresponding EMF thresholds. Thus, by way of example, an EMF-based system utilizing an inventive EM conductor and correspondingly configured magnet(s), can greatly boost system performance by positioning the novel EM conductor very close to the corresponding magnet(s) (e.g., as close as 0.001 mm, or closer), but without generating the corresponding high EMR thresholds, thus advantageously enabling the high performance EMF-based system to freely operate (when, for example, a conventionally designed EMF-based system of a similar scope, in which a wire coil was placed within 0.001 mm of the magnet(s), would be unable to even overcome the start-up EMR threshold and thus would not function al all).

Essentially, the key reason for the advantageous properties of the novel EM conductor, in addition to the shape and spatial configuration thereof, is the substantial absence of magnetic properties in the novel EM conductor (because the novel EM conductor does not use a magnetic core (for example, a core composed of a ferromagnetic material, such as iron), as do conventional wire coils, which are typically wound around a corresponding core). Accordingly, while the inventive EM conductor preferably has a high degree of electrical conductivity, its substantial lack of a magnetic field serves to prevent the formation of any significant EMR threshold in an EMF-based system equipped therewith.

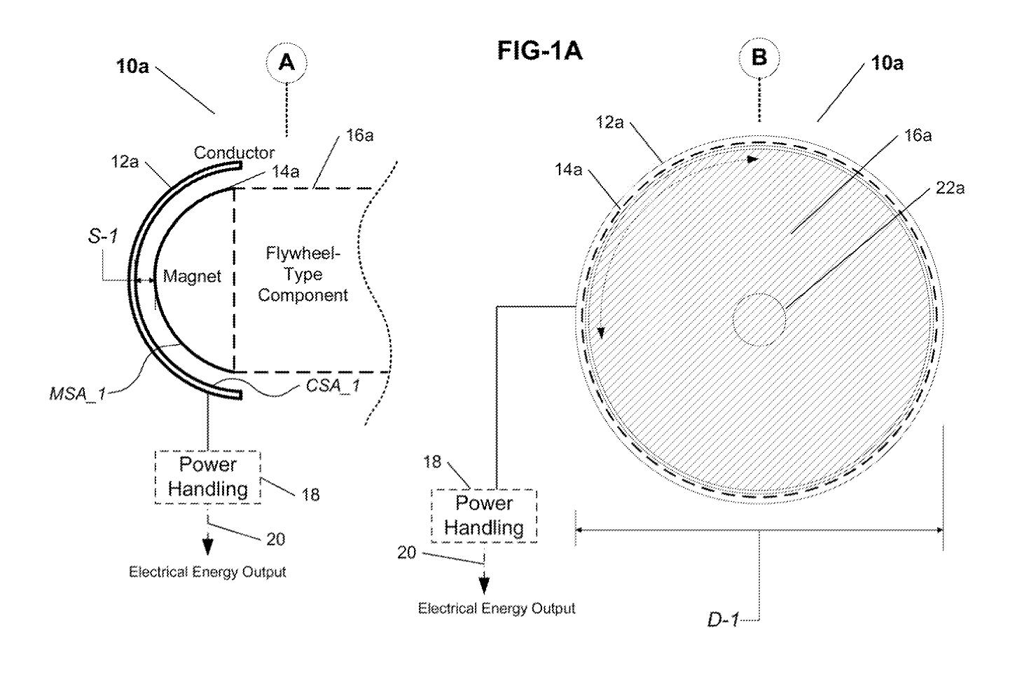

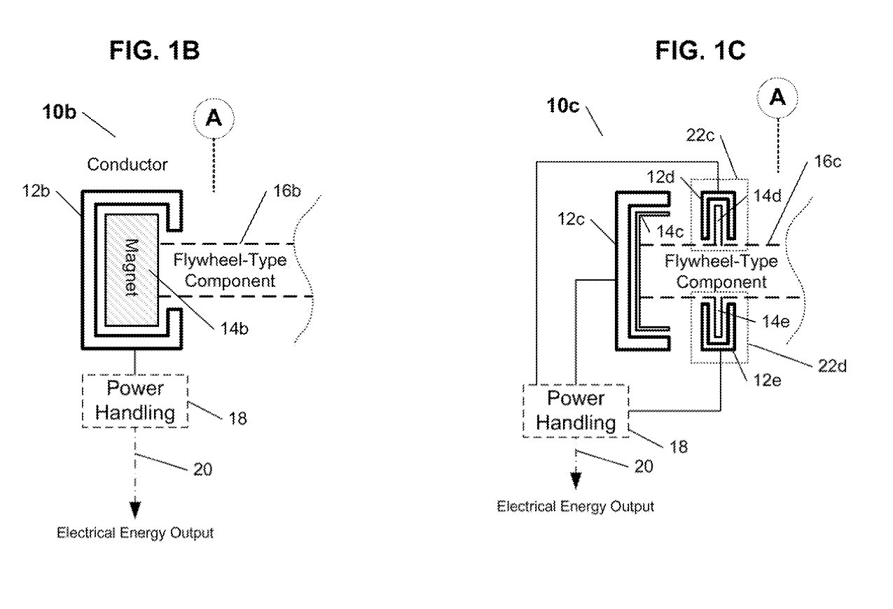

As is described in greater detail below in connection with FIGS. 1A to 6, the inventive EM conductor, in various embodiments thereof, advantageously solves the challenge of overcoming both types of EMR thresholds in any EMF-based system, by allowing the EMR threshold to be optimized (e.g., decreased), without any negative impact on the EMF-based system performance, thereby vastly increasing the EMF-based systems' efficiency, reliability, and sustainability of operation, as well as lowering their cost of operation and fabrication.

It should also be noted that in the various drawing FIGS. 1A to 6, and in accompanying descriptions herein, various inventive EM conductor shapes, sizes, as well as the shapes, sizes and designs of various inventive EM conductor elements, components and features, that may be provided in accordance with the present invention, are shown by way of example only, and, subjects to specific descriptions herein, shall not serve as a limitation on the type, size or configuration of shapes, elements, components and features that are protected or protectable by the patent claims presented herewith.

Furthermore, for the avoidance of any doubt, the inventive EM conductor is completely scalable, and may thus be readily utilized in systems ranging from small portable devices, to industrial scale power generation facilities, as a matter of design choice, without departing from the spirit of the present invention. In addition, as is the case with conventional EM conductors, it should be noted, for various embodiments of the present invention utilizing conductive wiring wound about the novel EM conductor's body, that in order to generate electrical energy (in generator-type EMF-based systems), or to provide rotary motion induced by provided electrical current (in motor-type EMF-based systems), the inventive EM conductor and the magnet(s) corresponding to the novel EM conductor, must be positioned and configured such that they are operable to move in a direction perpendicular to one another—for example, if the wires of the novel EM conductor are wound in a particular direction, the magnet must be configured to move in a direction perpendicular to the particular direction of the EM conductor's windings.

Moreover, it is readily contemplated that various embodiments of the inventive EM conductor of FIGS. 1A to 6, may be produced from virtually any electromagnetically active (i.e., conductive) material, or combination of materials, that may be selected as a matter of design choice, convenience, or necessity, without departing from the spirit of the present invention.

Additionally, it should be noted that because otherwise than as specified herein, the inventive EM conductor does not alter the mode of operation of various EMF-based systems in which it may be implemented as a component thereof, and because conventional EMF-based systems are well known in the art, there is no need to show or describe the components and elements of EMF-based systems herein that are not directly relevant to the inventive EM conductor.

Referring now to FIG. 1A, an exemplary schematic diagram is shown, in two views—a partial cross-section view A, and a top-plan view B, illustrating a first exemplary embodiment of the inventive. EM conductor, shown as an EM conductor apparatus 10a, configured for advantageous utilization in various rotary-motion based EMF-based systems (shown herein as being implemented in an electromechanical power generation system, by way of example).

The EM conductor apparatus 10a includes an EM conductor component 12a, shown herein in an exemplary open semi-circular coil configuration (see view A of FIG. 1A), that extends over, and circumferentially surrounds, a generally circular magnet component 14a that is preferably positioned along an outer circumferential region of a rotary component 16a (such as a flywheel, disc, etc.), that is in turn mounted on a support component 22a (such as an axle, etc.). The EM conductor component 12a is preferably composed from an electrically conductive material (but in contrast to a conventional wire coil conductor, does not comprise, and is not wound around, any magnetic core), and preferably comprises an inner conductor surface region CSA_1, oriented toward, and facing, a corresponding outer magnet surface region MSA_1 (of the magnet component 14a), such that the surface areas CSA_1 and MSA_1 are positioned at a distance S-1 from one another. It should be noted that the specific types of magnet components/elements utilized in various embodiments of the present invention may be selected as a matter of design choice without departing from the spirit of the invention. For example, the magnet component 14a of FIG. 1A, may be at least one of: a plural pole magnet, an electromagnet, a molecule-based magnet, a neodymium magnet, a rare earth magnet, a plastic magnet, a programmable magnet, a samarium cobalt magnet, a cunife magnet, and an alnico magnet.

Preferably, in accordance with the present invention, the shapes and sizes of the CSA_1 and MSA_1 are complementary to one another, such that CSA_1 forms a substantial inverse of MSA_1 at a distance of S-1 therefrom. Preferably, the values of the surface areas of each region CSA_1 and MSA_1 are substantially similar to one another. As is noted above, during apparatus 10a operation, in which the rotary component 16a rotates about its axis on the support component 22a, and thus rotates the magnet component 14a within the space encompassed by the CSA_1 region of the EM conductor component ‘12a, a smaller value of S-1, corresponds to greater system performance and efficiency, but without incurring the corresponding negative EMR effects (i.e., EMR thresholds).

The magnet component 14a may comprise a single elongated magnet element along the outer circumference of the rotary component 16a, or, without departing from the spirit of the present invention, it may comprise a plurality of magnet elements each comprising a portion of the region MSA_1 and positioned sequentially and proximally to one another, along the outer circumference of the rotary component 16a. Similarly, the EM conductor component 12a may also comprise a single element, or a plurality of sequentially connected elements positioned to at least partially circumferentially envelop the magnet component 14a.

When rotary motion is imparted to the support component 22a, it transfers that motion to the rotary component 16a, which rotates about its axis on the and thus rotates the magnet component 14a within the space encompassed by EM the CSA_1 region of conductor component 12a, thereby moving the MSA_1 region of the magnet component 14a proximally to the CSA_1 region at a distance of S-1 therefrom, and accordingly inducing an electrical current in the conductor component 12a, which is readily output therefrom.

The EM conductor component 12a may be connected to an optional power handling component 18, which may be provided for handling, and optionally otherwise processing, the electrical energy generated as a result of the apparatus 10a operation (such as AC/DC or vice versa conversion, rectification, transformation, regulation, conditioning, etc.), and for thereafter transmitting an electrical energy output 20 to its predetermined destination (i.e., to a local or remote electrical load, battery storage, transmission line, etc.).

Advantageously, the apparatus 10a is fully scalable, in that the diameter D-1 thereof can range from a very small value for handheld devices, all the way up to massive industrial-scale power generators, without departing from the spirit of the invention. Additionally, it should be noted that only the relative motion between the EM component and the magnet component is necessary—therefore, the inventive EM component apparatus 10a (or other embodiments thereof), may alternately be configured to rotate the EM conductor component 12a about a stationary magnet component 14a, as a matter of design choice or necessity, without departing from the spirit of the invention.

Moreover, it should be noted that the specific shapes of the inventive EM conductor component, and the corresponding magnet component, may readily vary across a wide range of matching complementary geometric cross-sectional configurations, without departing from the spirit of the invention, as long as the CSA_1 and MSA_1 regions thereof are facing one another in a substantially similar manner as shown in FIG. 1A (and preferably comprise similar surface area values). One such geometric cross-sectional variation is shown, by way of example only, in FIG. 1B, and is discussed in greater detail below in connection therewith.

Referring now to FIG. 1B, an exemplary schematic diagram is shown, in a partial cross-section view A, illustrating a second exemplary embodiment of the inventive EM conductor, shown as an EM conductor apparatus 10b, configured for advantageous utilization in various rotary-motion based EMF-based systems (shown herein as being implemented in an electromechanical power generation system, by way of example).

The EM conductor apparatus 10b operates in a substantially the same manner as the EM conductor apparatus 10a of FIG. 1A, and comprises elements 12b to 16b (and optional element 18), that correspond to the elements 12a to 16a of FIG. 1A in their operation and functionality, except that the EM conductor component 12b, and the corresponding magnet component 14b, are shaped differently from EM conductor component 12a/magnet component 14a. Specifically the magnet component 14b comprises a rectangular cross-section, and the EM conductor component 12b correspondingly comprises an rectangular cross-section with an open slot, along its internal circumferential outer region, that is sized and configured to receive the outer circumferential portion of the rotary component 16b therethrough, and also comprises an internal cavity region sized and configured to receive the magnet component 14b therein, such that its outer surface region MSA_1 is facing the EM conductor component 12b inner surface region CSA_1 (preferably, at a distance S-1 therebetween).

Advantageously, due to its capability of substantially eliminating EMR thresholds in EMF-based systems, the inventive EM conductor enables many novel EM conductor apparatus configurations, that would otherwise not be feasible. For example, the inventive EM conductor apparatus may comprise multiple matching sets of EM conductor components and corresponding magnet components positioned on a single rotary component. Without the suppression/substantial elimination of the EMR thresholds by the inventive EM conductor, an electromechanical system utilizing conventional wire coils as conductors, would simply not be able to overcome the multiple simultaneous EMR thresholds that would be generated in such a system as a result of multiple wire coil and magnet sets.

It should be noted that in various exemplary embodiments of the inventive EM conductor apparatus comprising multiple matching sets of EM conductor components and corresponding magnet components, such plural component sets can be positioned both along the outer circumferential region of the rotary component as well on the upper and/or lower surface regions thereof, without departing from the spirit of the invention. One such exemplary embodiment of the present invention is shown in FIG. 1C, and described in greater detail below in connection therewith.

Referring now to FIG. 1C, an exemplary schematic diagram is shown, in a partial cross-section view A, illustrating a third exemplary embodiment of the inventive EM conductor, shown as an EM conductor apparatus 10c, configured for advantageous utilization in various rotary-motion based EMF-based systems (shown herein as being implemented in an electromechanical power generation system, by way of example).

The EM conductor apparatus 10c operates in a substantially the same manner as the EM conductor apparatus 10a of FIG. 1A, and comprises elements 12c to 16c (and the optional element 18) that correspond to the elements 12a to 16a of FIG. 1A in their operation and functionality (with the elements 12c, 14c being semi-rectangular, rather than semi-circular), except that the EM conductor apparatus 10c further includes at least one additional EM conductor/magnet matching component set (shown by way of example only as EM conductor/magnet component set 22c (comprising EM conductor component 12d and magnet component 14d) the, and set 22d (comprising EM conductor component 12e and magnet component 14e)), each positioned on a different surface region of the rotary component 16c (and, if the apparatus 10c is supplied with the power handling component 18, each connected thereto).

Advantageously, during operation of the EM conductor apparatus 10c, the EM conductor/magnet component sets 22c, 22d each generate electrical energy in addition to the output of the primary EM conductor component 12c/magnet component 14c, thus enabling the EM conductor apparatus 10c to provide a significantly higher electrical energy output than the EM conductor apparatus 10a, 10b, in a similar, but slightly larger form factor.

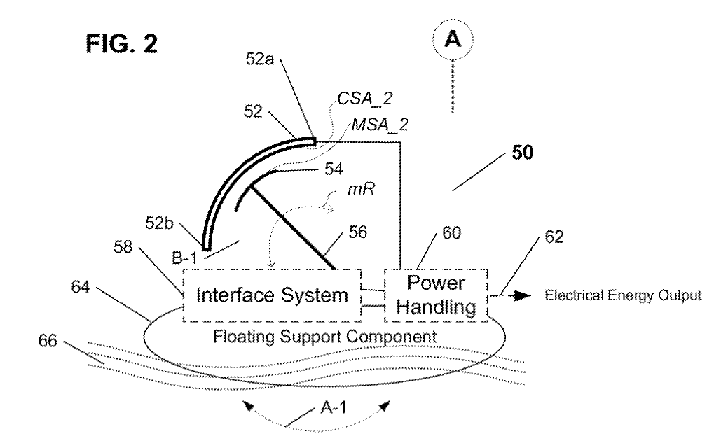

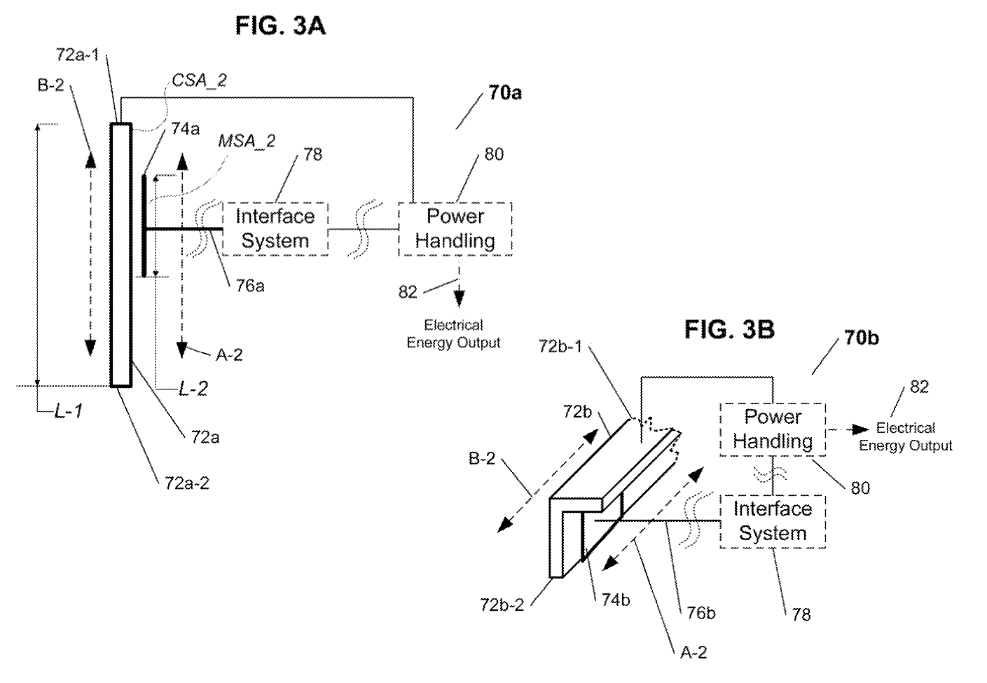

While various exemplary embodiments of the inventive EM conductor apparatus were shown and described in FIGS. 1A to 1C above, as being implemented in rotary EMF-based systems, it should be noted that the EM conductor apparatus of the present invention may be readily implemented in other types of EMF-based systems, such as wave-motion and/or reciprocating systems. Exemplary embodiments of the inventive EM conductor apparatus in such alternate configurations are shown in FIG. 2 (wave-motion system), and in FIGS. 3A and 3B (reciprocating system), and described in greater detail below in connection therewith.

Referring now to FIG. 2, an exemplary schematic diagram is shown, in a cross-section view A, illustrating a first exemplary alternate embodiment of the inventive EM conductor, shown as an EM conductor apparatus 50, configured for advantageous utilization in various wave-motion based EMF-based systems (shown herein as being implemented in a marine (i.e., floating) electromechanical power generation system by way of example).

The EM conductor apparatus 50 includes an EM conductor component 52, shown herein in an exemplary open semi-circular coil configuration (illustrated by way of example only as a quarter-circle), extending along an arcuate semicircular path between a first end 52a and the second end 52b, and also includes a smaller sized magnet component 54 having an outer surface shaped in a complementary manner to the inner geometry of the EM conductor component 52, and that is sized, configured and positioned for bi-directional movement along the inner surface of the EM conductor component 52, between the ends 52a, 62b thereof. The magnet component 54 is preferably positioned on a mobile mounting component 56, that is preferably operable to reciprocally move within a predefined arcuate motion range mR, thus enabling the magnet component 54 to reciprocally move between ends 52a and 52b of the EM conductor component 52.

The EM conductor component 52 is preferably composed from an electrically conductive material (but in contrast to a conventional wire coil does not comprise, and is not wound around, any magnetic core), and preferably comprises an inner conductor surface region CSA_2 oriented toward and facing, a corresponding complementary (but smaller) outer magnet surface region MSA_2 of the magnet component 54, such that (1) the surface areas CSA_2 and MSA_2 are positioned at a distance S-1 from one another; and (2) during operation of the EM conductor apparatus 50, the MSA_2 region moves along the CSA_2 region back and forth, between EM conductor component 52 ends 52a, 52b.

By way of example only, when implemented in a marine environment 66 in which waves are present, the EM conductor apparatus 50 also includes a floating support component 64 on which all other elements thereof are positioned and mounted. To enable more effective generation of the necessary reciprocating motion in the mobile mounting component 56, the inventive EM conductor apparatus 50 may include an optional interface system 58 (which may be a mechanical motion translation or transmission system, or the like).

During the operation of the EM conductor apparatus 50, the motion of the marine environment 66, causes wave-motion A-1 in the EM conductor apparatus 50, which is preferably translated (directly, or for example through the optional interface system 58) to reciprocating motion B-1 of the mobile mounting component 56 that in turn reciprocally moves the magnet component 54 (within the predefined arcuate motion range mR) between ends 52a and 52b of the EM conductor component 52, and that accordingly induces an electrical current in the conductor component 52, which is readily output therefrom.

The EM conductor component 52 may be connected to an optional power handling component 60 which may be provided for handling and optionally otherwise processing the electrical energy generated as a result of the apparatus 50 operation (such as AC/DC or vice versa conversion, rectification, transformation, regulation, conditioning, etc.), and for thereafter transmitting an electrical energy output 62 to its predetermined destination (i.e., a local or remote electrical load, battery storage, transmission line, etc.).

Advantageously, in a similar manner to the other embodiments of the present invention, the apparatus 50 is fully scalable, and may be implemented in sizes from a small self-sufficient buoy, all the way up to configurations sized massive floating platforms (oil rig, industrial power generation, data centers, etc.), without departing from the spirit of the invention.

Referring now to FIG. 3A, an exemplary schematic diagram is shown, in a cross-section view A, illustrating a second exemplary alternate embodiment of the inventive EM conductor, shown as an EM conductor apparatus 70a, configured for advantageous utilization in various linear reciprocating based EMF-based systems (shown herein as being implemented in an electromechanical power generation system by way of example).

The EM conductor apparatus 70a includes an EM conductor component 72a, shown herein in an exemplary elongated planar configuration, extending along a linear path between a first end 72a-1 and the second end 72a-2, and also includes a smaller sized magnet component 74a having a planar outer surface, and that is sized, configured and positioned for bi-directional movement along the inner surface of the EM conductor component 72a, between the ends 72a-1, 72a-2 thereof. The magnet component 74a is preferably positioned on a mobile mounting component 76a, that is preferably operable to reciprocally move along a predefined linear path A-2, thus enabling the magnet component 74a to reciprocally move between ends 72a-1 and 72a-2 of the EM conductor component 72a.

The EM conductor component 72a is preferably composed from an electrically conductive material (but in contrast to a conventional wire coil does not comprise, and is not wound around, any magnetic core), and preferably comprises an inner conductor surface region CSA_2 oriented toward and facing, a corresponding complementary (but smaller) outer magnet surface region MSA_2 of the magnet component 74a, such that (1) the surface areas CSA_2 and MSA_2 are positioned at a distance S-1 from one another; and (2) during operation of the EM conductor apparatus 70a, the MSA_2 region moves along the CSA_2 region back and forth, between EM conductor component 72a ends 72a-1, 72a-2.

To enable more effective generation of the necessary reciprocating motion in the mobile mounting component 76a, the inventive EM conductor apparatus 70a may include an optional interface system 78 (which may be a mechanical motion translation or transmission system, or the like). For example, the inventive EM conductor apparatus 70a may be readily used in marine environments if provided with an interface system 78 that is capable of translating the motion of the waves into linear reciprocating motion.

During the operation of the EM conductor apparatus 70a, reciprocating motion A-2 of the mobile mounting component 76a reciprocally moves the magnet component 74a between ends 72a-1 and 72a-2 of the EM conductor component 72a, and therefore induces an electrical current in the conductor component 72a, which is readily output therefrom. Alternately, because only relative motion of the regions CSA-2 and MSA_2 with respect to one another is necessary, the positions of the EM conductor component 72a and the magnet component 74a may be reversed, such that the EM conductor component 72a is mounted on the mobile mounting component 76a, such that during EM conductor apparatus 70a operation, the magnet component 74a remains stationary, while reciprocating motion B-2 of the mobile mounting component 76a, moves the EM conductor component 72a with respect thereto.

The EM conductor component 72a may be connected to an optional power handling component 80 which may be provided for handling and optionally otherwise processing the electrical energy generated as a result of the apparatus 70a operation (such as AC/DC or vice versa conversion, rectification, transformation, regulation, conditioning, etc.), and for thereafter transmitting an electrical energy output 82 to its predetermined destination (i.e., a local or remote electrical load, battery storage, transmission line, etc.). Advantageously, in a similar manner to the other embodiments of the present invention, the apparatus 70a is fully scalable.

Referring now to FIG. 3B, an exemplary schematic diagram is shown, in a partial cross-section view A, illustrating a third exemplary embodiment of the inventive EM conductor, shown as an EM conductor apparatus 70b, configured for advantageous utilization in various linear reciprocating EMF-based systems (shown herein as being implemented in an electromechanical power generation system by way of example).

The EM conductor apparatus 70b operates in a substantially the same manner as the EM conductor apparatus 70a of FIG. 3A, and comprises elements 72b to 76b (and optional elements 78, 80) that correspond to the elements 72a to 76a of FIG. 3A in their operation and functionality, except that the EM conductor component 72b, and the corresponding magnet component 74b, are shaped differently from EM conductor component 72a/magnet component 74a of FIG. 3A. Specifically the magnet component 74b comprises a generally “L”-shaped cross-section, and the EM conductor component 72b correspondingly comprises an correspondingly larger sized “L”-shaped cross-section, further comprising an internal surface region sized and configured to receive the magnet component 74b therein, such that its outer surface region MSA_2 is facing the EM conductor component 72b inner surface region CSA_2 (preferably at a distance S-1 therebetween).

It should be noted that the specific shapes of the linear reciprocating embodiments of the inventive EM conductor component (shown by way of example only in FIGS. 3A and 3B), and the corresponding magnet component may readily vary across a wide range of matching complementary geometric cross-sectional configurations, without departing from the spirit of the invention, as long as the CSA_2 and MSA_2 regions thereof are facing one another in a substantially similar manner as shown in FIGS. 3A and 3B.

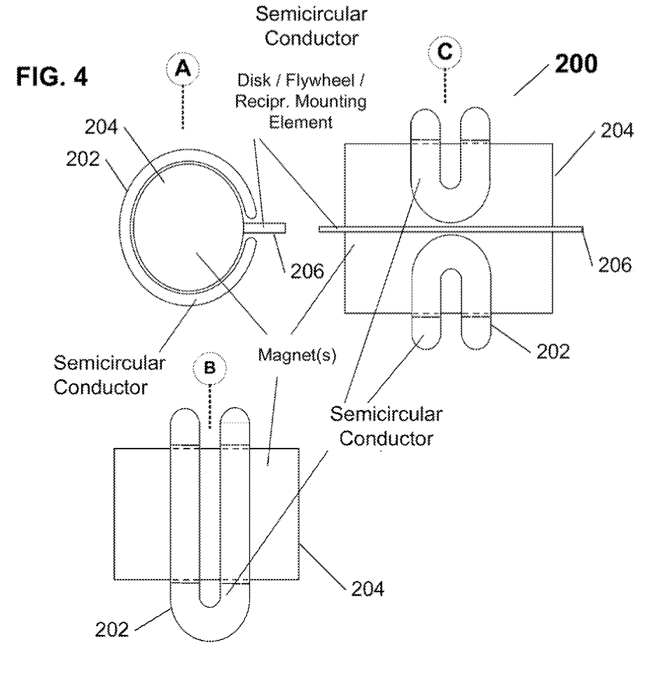

Referring now to FIG. 4, an exemplary schematic diagram is shown, in a cross-section view A, in a top-down plan view B, and in a planar “inside-out” view C, illustrating an exemplary alternate embodiment of the inventive EM conductor, shown as an EM conductor apparatus 200, configured for advantageous utilization in various rotary, or linear reciprocating, EMF-based systems (and may also be readily adapted/configured for implementation as any of the EM conductor apparatuses 10a to 70b of FIGS. 1A to 3B, operating in a manner that is described above for each embodiment of the EM conductor apparatus in connection with each of the FIGS. 1A to 3B.

The EM conductor apparatus 200 includes a semicircular “C”-shaped EM coil conductor 202 (hereinafter referred to by way of example as the “C-coil 202”), that is geometrically configured in a manner clearly illustrated by the various views A to C. A corresponding circular cross-section magnet component 204 is positioned within an inner cavity region defined by the C-coil 202, that is mounted on a component 206 (which may be a rotary element or a reciprocating mounting element depending on the type of the EM conductor apparatus 200 (rotary versus reciprocating). It should be noted that research and experimentation conducted in connection with development of the inventive EM conductor have demonstrated EM conductor configurations based on the C-coil 202, or variants thereof (e.g., smaller circumferential cross-sectional lengths), to be particularly effective.

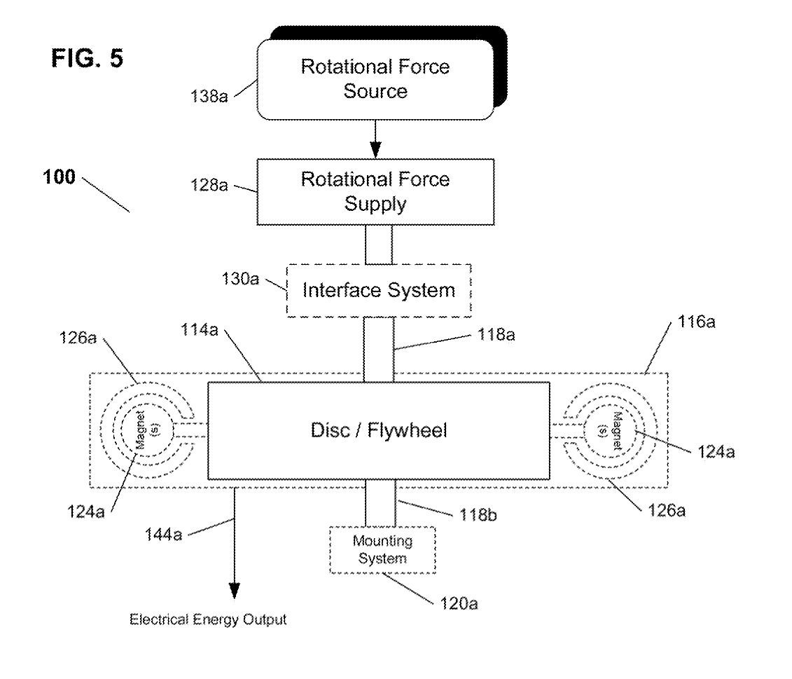

Referring now to FIG. 5, an exemplary schematic block diagram is shown in a simplified cross-sectional view of an exemplary implementation of various embodiments of inventive EM conductor apparatus of FIGS. 1A-1C, and FIG. 4, as a component in an exemplary electromechanical electrical power generation system, shown herein by way of example only as the novel HEAS Generator 100 disclosed and described in greater detail in the above-incorporated co-pending commonly assigned HEAS Generator Patent Application. In summary the HEAS Generator 100 comprises a disc/flywheel 114a with a magnet component 124a mounted circumferentially along its outside periphery, and rotatably positioned within an inner toroidal cavity defined by an EM conductor component 126a (which may be a C-coil type EM conductor, such as the C-coil 202 of FIG. 4).

Optionally, the EM conductor component 126a and the magnet component 124a (as well as the disc/flywheel 114a) may be disposed in a housing 116a, which may optionally comprise a medium surrounding the housed components (such as coolant—e.g., liquid nitrogen) that is operable of further enhancing the performance of the EM conductor component 126a/magnet component 124a (for example, in case of a coolant medium, by increasing conductivity thereof). In essence, the HEAS Generator 100 is powered by a rotational force supply 128a, which, through an axle element 118a, imparts rotary motion to the disc/flywheel 114a that is necessary for HEAS Generator 100 operation, produced in response to rotational force delivered thereto from a rotational force source 138a (which may range from direct rotary force, to indirect rotary force translated mechanically or otherwise produced). When the rotational force supply 128a is active, the HEAS generator produces electrical energy output 144a from the electrical current induced by rotation of the magnet component 124a within the EM conductor component 126a.

The HEAS Generator 100 may also include additional optional components, such as an optional interface system 130a for enhancing or otherwise modifying the rotary motion provided by the rotational force supply 128a, and may also include an optional mounting system 120a for improving the operation of the axle element 118a.

As described in greater detail in the HEAS Generator Patent Application, the HEAS Generator 100 provides an excellent and optimal platform for maximizing the advantageous features and aspects of the various embodiments of the novel EM conductor of the present invention, is fully scalable, and configurable for simplified implementation in virtually any application which requires provision of electrical energy.

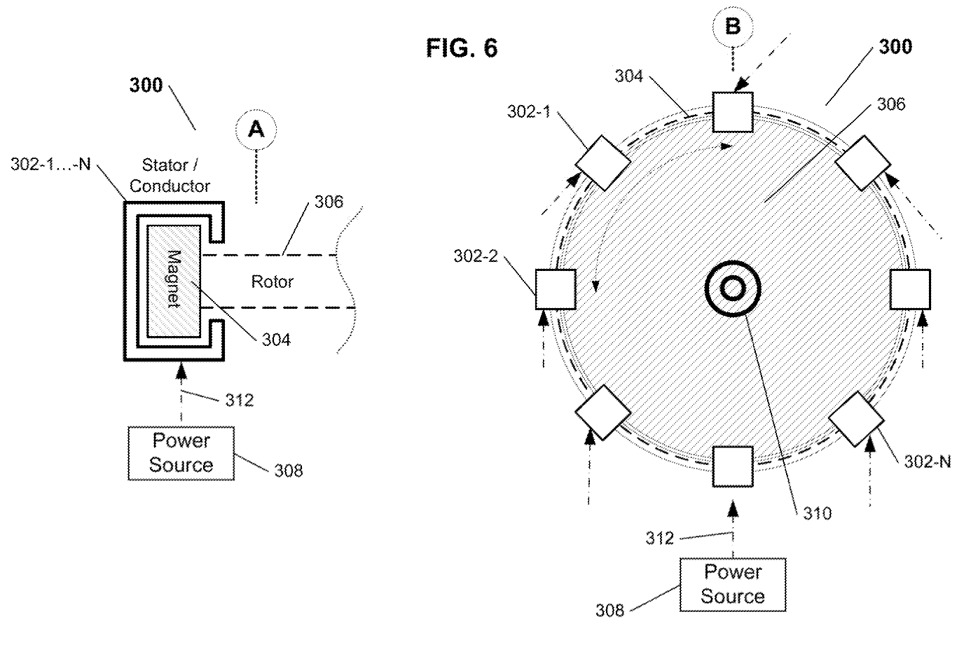

As was noted above, the inventive EM conductor is readily applicable in virtually all EMF-based systems. While various embodiments of the novel EM conductor have been described and illustrated, by way of example, in connection with their use in electrical power generation applications, an alternate embodiment of the inventive EM conductor apparatus utilized in an electrical motor application is shown, by way of example, in FIG. 6.

Referring now to FIG. 6, an exemplary schematic diagram is shown, in two views—a partial cross-section view A, and a top-plan view B, illustrating an exemplary embodiment of the inventive EM conductor, shown as an EM conductor apparatus 300, configured for advantageous utilization in various rotary-motion based EMF-based electromechanical systems (shown herein as being implemented in an electrical motor system by way of example).

The EM conductor apparatus 300 includes a plurality of EM conductor components 302-1 . . . N, shown herein in an exemplary open semi-rectangular coil configuration (see view A of FIG. 6), that extends and circumferentially surrounds a generally rectangular cross-section magnet component 304, that is preferably positioned along the outer circumferential region of a rotary component 306 (such as a flywheel, disc, etc.), that is in turn mounted on an output component 310 (such as an axle, etc.). The EM conductor components 302-1 . . . N are preferably composed from an electrically conductive material (but in contrast to a conventional wire coil, does not comprise, and is not wound around, any magnetic core).

Essentially, the EM conductor apparatus 300 operates in a directly opposite manner to that of the EM conductor apparatus 10a of FIG. 1A—rather than outputting electrical energy 20, the EM conductor apparatus 300 receives electrical current 312 (from a power source 308), that is passed through the plural EM conductors 302-1 . . . N, and that induces the motion of the magnet component 304, which in turn causes rotation of the rotary component 308, imparting the desired rotational force to the output component 310.

Thus, while there have been shown and described and pointed out fundamental novel features of the inventive apparatus as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

I claim:

1. A conductor apparatus, for optimizing electromagnetic resistance in an electromechanical system operable, in response to a predetermined input, to perform a predefined function to produce a corresponding output, the electromechanical system, having a first component comprising a first at least one surface, and having a second component positioned proximally thereto comprising a second at least one surface, wherein at least a portion of the first at least one surface and at least a portion of the second at least one surface are oriented toward one another, and wherein at least one of the first and second components are operable to move with respect to one another, the conductor apparatus comprising:
at least one magnet, positioned in at least one predefined region of the first at least one surface of the first component, said at least one magnet comprising at least one magnet surface region; and
at least one conductor component, operable to conduct electrical energy therethrough and configured to substantially prevent formation of an inherent electromagnetic field therein, positioned in at least one predefined region of the second at least one surface of the second component, proximal to said at least one magnet, and comprising at least one conductor surface region, wherein said at least one magnet surface region and said at least one conductor surface region are positioned and configured to be substantially oriented towards one another at a predetermined first distance therebetween, and wherein at least one of: relative shapes and surface areas of said at least one conductor surface region and said at least one magnet surface region, said predetermined first distance, material composition of said at least one conductor component, and said at least one magnet's magnetic characteristics, are selected and configured to reduce the electromagnetic resistance opposing relative motion between said at least one magnet and said at least one conductor component.

2. The conductor apparatus of claim 1, wherein said at least one conductor component comprises at least one open coil configured and positioned to proximally align with only a predetermined portion of an outer circumferential surface at said at least one magnet.

3. The conductor apparatus of claim 2, wherein said at least one open coil comprises one of: a generally C-shaped cross-section, a generally U-shared cross section, a generally arcuate cross-section, and a generally straight elongated cross-section.

4. The conductor apparatus of claim 1, wherein said at least one conductor component comprises a winding of an elongated conductive material about its outer surface, said winding being oriented in a predetermined direction, wherein said predetermined direction is substantially perpendicular to a preconfigured direction of respective movement between said at least one conductor component and said at least one magnet.

5. The conductor apparatus of claim 1, wherein the electromechanical system comprises an electrical power generator, wherein the predefined function is generation of electrical energy, wherein the predetermined input comprises mechanical motion imparted to at least one of the first and second electromechanical system components from an external motion source, and wherein the predetermined output comprises electrical energy.

6. The conductor apparatus of claim 5, wherein said mechanical motion imparted to the at least one of the first and second electromechanical system components, is selected from a plurality of motion types comprising: rotary motion, oscillating motion, and reciprocating motion, and wherein the first and the second components are configured to enable relative motion therebetween in a predetermined respective motion profile, corresponding to said plural motion type imparted thereto.

7. The conductor apparatus of claim 5, wherein said external motion source comprises at least one of: a wind turbine, a mobile marine structure, a relative movement of a structure mechanically communicating with the electromechanical system, and a water wheel.

8. The conductor apparatus of claim 5, wherein one of the at least one first and second electromechanical system components, comprises flywheel functionality, and is therefore operable to sustain rotary motion imparted thereto for a predetermined period of time after cessation thereof.

9. The conductor apparatus of claim 8, wherein said at least one flywheel functional component comprises an outer circumferential region corresponding to one of the first and second at least one surface, wherein the other at least one component is positioned and configured to substantially surround said outer circumferential region, further comprising an internal region configured to correspond to the other of the first and second at least one surface, and having an opening corresponding to said outer circumferential region, being positioned proximally thereto, wherein said at least one magnet is disposed in in one of said outer circumferential region and said inner region, and wherein said at least one conductor component is disposed in the other of said outer circumferential region and said inner region.

10. The conductor apparatus of claim 1, wherein said at least one conductor component comprises a plurality of conductor components forming a plurality of corresponding conductive regions, wherein said at least one magnet comprises a plurality of magnets forming a plurality of corresponding magnetic regions, wherein said plural conductor components and said plural magnets are each positioned, sized and configured to selectively cause the respective conductive and magnetic regions to move with respect to one another during operation of the electromechanical system, while minimizing electromagnetic resistance between each corresponding plural conductor and plural magnet.

11. The conductor apparatus of claim 6, wherein said relative motion between said at least one conductor component and said at least one magnet, in accordance with said motion profile, causes electrical energy to be induced in said at least one conductor component.

12. The conductor apparatus of claim 11, further comprising means for collecting said induced electrical energy from said at least one conductor component, and for transmitting said collected electrical energy as the electromechanical system output.

13. The conductor apparatus of claim 1, wherein at least a portion of said at least one conductor component is disposed within a medium having properties that increase conductivity thereof.

14. The conductor apparatus of claim 13, wherein said medium is selected to elevate the conductivity characteristic of said at least one conductor component to a superconductive magnitude.

15. The conductor apparatus of claim 1, wherein the electromechanical system comprises an electrical motor, wherein the predefined function is generation of mechanical motion, wherein the predetermined input comprises electrical energy imparted to at least one of the first and second electromechanical system components from an external electrical power source, and wherein the predetermined output comprises at least one predefined type of mechanical motion.

16. The conductor apparatus of claim 10, wherein said plurality of conductor components comprises at least one plural conductor component of at least one predefined configuration selected from a first at least one conductor configuration, and at least one other plural conductor component of at least one other configuration selected from a second at least one conductor configuration, and wherein said plurality of magnets comprises at least one plural magnet of at least one predefined magnet configuration selected from a first at least one magnet configuration, and at least one other plural magnet of at least one other magnet configuration selected from a second at least one magnet configuration.

17. The conductor apparatus of claim 1, wherein said at least one magnet is selected from a group comprising at least one of: a plural pole magnet, an electromagnet, a molecule-based magnet, a neodymium magnet, a rare earth magnet, a plastic magnet, a programmable magnet, a samarium cobalt magnet, a cunife magnet, and an alnico magnet.

18. A conductor apparatus, for optimizing electromagnetic resistance in an electrical power generator operable, in response to predetermined mechanical motion provided thereto to output electrical energy, the electrical power generator, having a first component comprising a first at least one surface, and having a second component positioned proximally thereto comprising a second at least one surface, wherein at least a portion of the first at least one surface and at least a portion of the second at least one surface are oriented toward one another, and wherein at least one of the first and second components are operable to move with respect to one another, the conductor apparatus comprising:
at least one magnet, positioned in at least one predefined region of the first at least one surface of the first component, said at least one magnet comprising at least one magnet surface region; and
at least one conductor component, operable to conduct electrical energy therethrough and configured to substantially prevent, formation of an inherent electromagnetic field therein, positioned in at least one predefined region of the second at least one surface of the second component, proximal to said at least one magnet, and comprising at least one conductor surface region, wherein said at least one magnet surface region and said at least one conductor surface region are positioned and configured to be substantially oriented towards one another at a predetermined first distance therebetween, and wherein at least one of: relative shapes and surface areas of said at least one conductor surface region and said at least one magnet surface region, said predetermined first distance, material composition of said at least one conductor component, and said at least one magnet's magnetic characteristics, are selected and configured to reduce the electromagnetic resistance opposing relative motion between said at least one magnet and said at least one conductor component, thus increasing efficiency, reliability and output capacity of the electrical power generator.

19. The conductor apparatus of claim 18, wherein said at least one conductor comprises at least one open coil configured and positioned to proximally align with only a predetermined portion of an outer circumferential surface at said at least one magnet.

20. The conductor apparatus of claim 18, wherein said at least one open coil comprises one of: a generally C-shaped cross-section, a generally U-shared cross section, a generally arcuate cross-section, and a generally straight elongated cross-section.

21. A method for optimizing electromagnetic resistance in an electromechanical system that is operable, in response to a predetermined input, to perform a predefined function to produce a corresponding output, the electromechanical system, having a first component comprising a first at least one surface, and having a second component positioned proximally thereto comprising a second at least one surface, wherein at least a portion of the first at least one surface and at least a portion of the second at least one surface are oriented toward one another, and wherein at least one of the first and second components are operable to move with respect to one another, the method comprising the steps of:
(a) positioning at least one magnet, in at least one predefined region of the first at least one surface of the first component, said at least one magnet comprising at least one magnet surface region;
(b) positioning at least one conductor component, operable to conduct electrical energy therethrough and configured to substantially prevent formation of an inherent electromagnetic field therein, in at least one predefined region of the second at least one surface of the second component, proximal to said at least one magnet, and comprising at least one conductor surface region, said relative positioning and configuration of said at least one magnet surface region and said at least one conductor surface region in accordance with said steps (a) and (b), causing substantial orientation thereof towards one another, at a predetermined first distance therebetween; and
(c) prior to said step (a), selecting and configuring at least one of:
relative shapes and surface areas of said at least one conductor surface region and said at least one magnet surface region, said predetermined first distance, material composition of said at least one conductor component, and said at least one magnet's magnetic characteristics, to reduce the electromagnetic resistance opposing relative motion between said at least one magnet and said at least one conductor component.

21. The method of claim 20, for optimizing electromagnetic resistance in an electromechanical system, wherein said at least one conductor component comprises at least one open coil, and wherein said step (c) further comprises the step of:
(d) configuring and positioning said at least one open coil to proximally align with only a predetermined portion of an outer circumferential surface at said at least one magnet.

22. The method of claim 21, for optimizing electromagnetic resistance in an electromechanical system, wherein said at least one open coil comprises one of: a generally C-shaped cross-section, a generally U-shared cross section, a generally arcuate cross-section, and a generally straight elongated cross-section.

23. The method of claim 21, for optimizing electromagnetic resistance in an electromechanical system, further comprising a step (e), prior to said step (b), providing a predefined medium having properties that increase conductivity of a conductive material immersed therein, and wherein said step (b) further comprises positioning said at least one conductor component such that at least a portion thereof is disposed within said predefined medium.

24. The method of claim 23, for optimizing electromagnetic resistance in an electromechanical system, further comprising a step (f), prior to said step (d), selecting said predetermined medium to comprise properties that elevate the conductivity characteristic of said at least one conductor component to a superconductive magnitude.

25. A method for optimizing electromagnetic resistance in an electrical power generator operable, in response to predetermined mechanical motion provided thereto, to output electrical energy, the electrical power generator having a first component comprising a first at least one surface, and having a second component positioned proximally thereto comprising a second at least one surface, wherein at least a portion of the first at least one surface and at least a portion of the second at least one surface are oriented toward one another, and wherein at least one of the first and second components are operable to move with respect to one another, the method comprising the steps of:
(a) positioning at least one magnet, in at least one predefined region of the first at least one surface of the first component, said at least one magnet comprising at least one magnet surface region;
(b) positioning at least one conductor component, operable to conduct electrical energy therethrough and configured to substantially prevent formation of an inherent electromagnetic field therein, in at least one predefined region of the second at least one surface of the second component, proximal to said at least one magnet, and comprising at least one conductor surface region, said relative positioning and configuration of said at least one magnet surface region and said at least one conductor surface region in accordance with said steps (a) and (b), causing substantial orientation thereof towards one another, at a predetermined first distance therebetween; and
(c) prior to said step (a), selecting and configuring at least one of: relative shapes and surface areas of said at least one conductor surface region and said at least one magnet surface region, said predetermined first distance, material composition of said at least one conductor component, and said at least one magnet's magnetic characteristics, to reduce the electromagnetic resistance opposing relative motion between said at least one magnet and said at least one conductor component, thus increasing efficiency, reliability and output capacity of the electrical power generator.
